(19) United States
(12) Patent Application Publication
(10) Pub. No.: US 2006/0278281 A1
(43) Pub. Date: Dec. 14, 2006

(54) Apparatus and method for closing a fluid path

(76) Inventors: Gunther von Gynz-Rekowski, Montgomery, TX (US); Robert R. McConnell, Lafayette, IN (US); John W. Robertson, Noblesville, IN (US)

Correspondence Address: CANTOR COLBURN, LLP, 55 GRIFFIN ROAD SOUTH, BLOOMFIELD, CT, 06002, US

(21) Appl. No.: 11/440,414

(22) Filed: May 24, 2006

Related U.S. Application Data
(60) Provisional application No. 60/683,915, filed on May 24, 2005.

(51) Int. Cl. F16K 37/00

(52) U.S. Cl. 137/554

(57) ABSTRACT

An apparatus for closing off a path in a fluid delivery system, comprising: a closing assembly providing a first fluid path between a first conduit and a second conduit, wherein the closing assembly comprises a remotely actuatable valve mechanism that closes the first fluid path and provides a second fluid path from either the first conduit or the second conduit to a third conduit, wherein the remotely acuatable valve mechanism closes the first fluid path when a predetermined condition is sensed in the fluid delivery system.

### CROSS REFERENCE TO RELATED APPLICATIONS

This application claims the benefit of U.S. Provisional Patent Application Ser. No. 60/683,915 filed May 24, 2005, the contents of which are incorporated herein by reference thereto.

### TECHNICAL FIELD

This present invention relates generally to an apparatus and method for monitoring the flow of a fluid or media in a conduit of a fluid transporting system. More specifically, the present invention relates to a method and apparatus for monitoring the flow of a fluid or media in a conduit, detecting the presence of a leak and isolating the leak from the fluid system.

### BACKGROUND

Fluid delivery systems comprise networks of pipes (e.g., conduits), pumps, holding tanks, reservoirs, etc. that provide a means for transporting fluids or media from a source to an end use destination. As used herein non-limiting examples of fluid or media include water, oil, acids, natural gas, nitrogen, drilling fluids, ore slurry, and the like, non-limiting examples of fluid delivery systems include crude oil delivery systems, natural gas delivery systems, municipal water systems each of which will comprise a network of pipe lines for transferring a fluid from one point to another.

In addition, these networks may comprise miles and miles of piping, which is located under or above ground and in remote areas. Furthermore, and due to the enormous size of these networks and the likelihood of a leak occurring in the system it is necessary to monitor the network for leaks. In addition, and unfortunately, these networks may also be susceptible to terrorist attacks.

Therefore, it is desirable to provide an apparatus and method for remotely monitoring the flow of the fluid in the system as well as providing a means for remotely shutting off or redirecting portions of the system when a leak has been detected. Moreover, it is also desirable to provide a means for remotely reporting whether the means for shutting off or redirecting portions of the system has been activated.

### SUMMARY

Disclosed herein is an apparatus for closing off a path in a fluid delivery system, comprising: a closing assembly providing a first fluid path between a first conduit and a second conduit, wherein the closing assembly comprises a remotely actuatable valve mechanism that closes the first fluid path and provides a second fluid path from either the first conduit or the second conduit to a third conduit, wherein the remotely acuatable valve mechanism closes the first fluid path when a predetermined condition is sensed in the fluid delivery system.

In another exemplary embodiment, the apparatus will provide a means for remotely indicating whether the closure system has been activated.

A fluid delivery system, comprising: a plurality of pipes providing at least one flow path; a plurality of closing assemblies each providing a first fluid path between a one of the plurality of pipes and another one of the plurality of pipes, wherein the closing assembly comprises a remotely actuatable valve mechanism that closes the first fluid path and provides a second fluid path from one of pipes to yet another pipe, wherein the remotely acuatable valve mechanism closes the first fluid path when a predetermined condition is sensed in the fluid delivery system.

A method for closing off a path in a fluid delivery system, comprising: monitoring a fluid traveling through the fluid delivery system with a plurality of sensors each of which is configured to provide an output signal corresponding to the fluid traveling through the fluid delivery system; determining if there is a leak in the fluid delivery system by receiving the output signals; determining the location of the leak and determining which of a plurality of closing mechanisms are to be activated in order to isolate the leak, wherein each closing mechanism provides a first fluid path between a first conduit and a second conduit, wherein the closing mechanism comprises a remotely actuatable valve mechanism that closes the first fluid path and provides a second fluid path from either the first conduit or the second conduit to a third conduit, wherein the remotely acuatable valve mechanism closes the first fluid path in response to a signal from one of the plurality of sensors.

In one exemplary embodiment, an apparatus for closing off a path in a fluid delivery system is provided. The apparatus comprising: a closing assembly providing a first fluid path between a first conduit and a second conduit, wherein the closing assembly comprises a remotely actuatable valve mechanism that closes the first fluid path between the first conduit and the second conduit, wherein the remotely acuatable valve mechanism closes the first fluid path when a predetermined condition is sensed by at least one sensor in the fluid delivery system; and an indication device for remotely indicating whether the remotely acuatable valve mechanism has been activated, wherein the indication device wirelessly transmits a signal indicating the status of the remotely acuatable valve mechanism; a control unit in operable communication with the at least one sensor, the indication device, and the remotely acuatable valve mechanism, wherein the control unit will provide an activation signal to the remotely acuatable valve mechanism when the predetermined condition has been detected by the at least one sensor; a closure detection sensor, the closure detection sensor being configured to provide a signal to the control unit, indicating an operational status of the remotely acuatable valve mechanism.

In another exemplary embodiment, a closure detection system for a fluid delivery system is provided, The closure detection system comprising: a plurality of closing assemblies each providing a fluid path therethrough, wherein each of the plurality of closing assemblies comprises a remotely actuatable valve mechanism that closes the fluid path when a predetermined condition is sensed by at least one sensor in the fluid delivery; an indication device for each of the plurality of closing assemblies, the indication device being configured to remotely indicate whether the remotely acuatable valve mechanism of one of the plurality of closing assemblies has been activated, wherein the indication device wirelessly transmits a signal indicating the status of the remotely acuatable valve mechanism.

In another exemplary embodiment, a fluid delivery system is provided. The fluid delivery system comprising: a plurality of pipes providing at least one flow path; a plurality of closing assemblies each providing a first fluid path between a one of the plurality of pipes and another one of the plurality of pipes, wherein the closing assembly comprises a remotely actuatable valve mechanism that closes the first fluid path and provides a second fluid path from one of pipes to yet another pipe, wherein the remotely acuatable valve mechanism closes the first fluid path when a predetermined condition is sensed by at least one sensor in the fluid delivery system proximate to each of the plurality of closing assemblies; and an indication device for each of the plurality of closing assemblies, the indication device being configured to remotely indicate whether the remotely acuatable valve mechanism of one of the plurality of closing assemblies has been activated, wherein the indication device wirelessly transmits a signal indicating the status of the remotely acuatable valve mechanism.

In yet another alternative exemplary embodiment, a method for closing off a path in a fluid delivery system is provided. The method comprising: monitoring a fluid traveling through the fluid delivery system with a plurality of sensors each of which is configured to provide an output signal corresponding to the fluid traveling through the fluid delivery system; determining if there is a leak in the fluid delivery system by receiving the output signals; determining the location of the leak and determining which of a plurality of closing mechanisms are to be activated in order to isolate the leak, wherein a selected closing mechanism is activated in order to isolate the leak, wherein each closing mechanism provides a first fluid path between a first conduit and a second conduit, and each closing mechanism comprises a remotely actuatable valve mechanism that closes the first fluid path and provides a second fluid path from either the first conduit or the second conduit to a third conduit, wherein the remotely acuatable valve mechanism closes the first fluid path in response to a signal from one of the plurality of sensors; and indicating that the selected closing mechanism has been activated by providing an indication signal to a central controller in operable communication with the fluid delivery system.

The above-described and other features of the present disclosure will be appreciated and understood by those skilled in the art from the following detailed description, drawings, and appended claims.

### DRAWINGS

FIG. 1 is a schematic illustration of an exemplary embodiment of the present invention;

FIG. 2 is a schematic illustration of another exemplary embodiment of the present invention;

FIG. 3 is a schematic illustration of still another exemplary embodiment of the present invention;

FIGS. 4A and 4B show operation of an exemplary embodiment of the present invention;

FIG. 5 is a cross-sectional view of an exemplary embodiment;

FIG. 6 is a schematic illustration of an exemplary embodiment;

FIGS. 7A and 7B illustrate an alternative exemplary embodiment of the present invention;

FIGS. 8 and 9 illustrate another mechanism for closing off fluid conduits;

FIGS. 10-19 illustrate other alternative mechanisms for closing off fluid conduits in accordance with exemplary embodiments of the present invention;

FIG. 20 is a schematic illustration of an exemplary embodiment of the present invention; and

FIG. 21 is a schematic illustration of an oil distribution network having a closure system in accordance with an exemplary embodiment of the present invention.

### DESCRIPTION OF EXEMPLARY EMBODIMENTS

Disclosed herein is an emergency closing assembly and method for immediately stopping the flow of a fluid in a conduit or carrier of a fluid transfer system. In accordance with an exemplary embodiment, the closing assembly is remotely located and capable of remote activation via signals received by sensors located within or proximate to the sensing assembly. In addition, the closing assembly is also equipped with a means for providing an indication to a remotely located control system when the closing assembly has been activated.

As used herein the term “fluid delivery system” may comprise a network or system for transferring fluid from a source to a destination. Non-limiting examples are crude oil delivery systems, natural gas delivery systems, municipal water systems each of which will comprise a network of pipe lines for transferring a fluid from one point to another.

In accordance with an exemplary embodiment of the present invention a novel emergency closing assembly is provided. The emergency closing assembly stops the flow of media or fluid in a fluid transfer system immediately, completely and without damaging effect to its surroundings or undamaged portion of the system. In addition, the emergency closing assembly will in exemplary embodiments be autonomous from any human intervention as well as independent from outside communication, information or signal. Thus, when predetermined conditions are sensed the appropriate mechanisms are actuated to close off certain fluid paths as well as providing an indication that the closing assembly has been activated.

In accordance with one exemplary embodiment the emergency closing system will stop the flow of media or fluid in a fluid transfer system completely over given time intervals, wherein the flow is slowly closed off by the closing system and back pressure is controlled as the system is closed off. Thus, damage to the system from abrupt flow stoppage is minimized or eliminated. In accordance with an exemplary embodiment the emergency closing system will stop the flow of media incompletely over given time intervals wherein back pressure is controlled as the system is closed off. This is achieved by redirecting fluid flow via the closing assembly or by utilizing a plurality of closing mechanisms to redirect or stop the flow of fluid through the fluid delivery system.

In accordance with an exemplary embodiment the emergency closing system will stop the flow of fluid or media after an occurrence that has been sensed by means of a sensor or sensors and other mechanisms.

In accordance with an exemplary embodiment the emergency closing system will stop the flow of fluid or media after information, which has been provided by means of a sensor or sensors and other mechanism, has been processed.

In accordance with an exemplary embodiment the emergency closing system will stop the flow of fluid or media after processed information triggers the activation of a closing mechanism.

In accordance with an exemplary embodiment the emergency closing system will stop the flow of fluid or media after a closing mechanism interrupts the flow of a media by means of placing the closing mechanism inside the carrier body of the media.

In accordance with an exemplary embodiment the emergency closing system will stop the flow of fluid or media by means of locking and sealing the closing mechanism of the carrier body of the media.

In accordance with an exemplary embodiment the emergency closing system will stop the flow of fluid or media, which stops the flow of media by a locking and sealing mechanism that will be locked until opening information is provided or the damage to the fluid delivery system has been prepared.

In accordance with one exemplary embodiment the emergency closing assembly will stop the flow of fluid or media with a locking and sealing mechanism wherein the locking and sealing mechanism is of a mechanical nature.

In accordance with another exemplary embodiment the emergency closing assembly will stop the flow of fluid or media with a locking and sealing mechanism wherein the locking and sealing mechanism is of a chemical nature.

In accordance with another exemplary embodiment the emergency closing assembly will stop the flow of fluid or media with a locking and sealing mechanism wherein the locking and sealing mechanism receives and interprets signals provided by sensors and similar mechanisms set or programmed to cause activation of the emergency closing assembly when a specific and selected physical condition is manifested inside or outside the carrier body of the media. Non-limiting examples of such physical conditions are damage to the pipes, wherein the fluid being transported is leaking out of the system. Thereafter, and after the system has been activated, exemplary embodiments include a means for providing an indication that the closure mechanism has been activated. In one exemplary embodiment, the means for providing the indication would be a sensor or other equivalent device for providing a signal indicative of the operational status of the closure mechanism (e.g., activated or non-activated) via remote transmission (e.g., RF transmission) to a central controller or computer in operable communication with the closure mechanisms.

In accordance with exemplary embodiments of the present invention the emergency closing assembly, which whether in the open and/or the closed position will communicate with an external and independent control unit and/or with other emergency closing units.

In accordance with another exemplary embodiment the emergency closing assembly can be activated by an internal or external occurrence of the carrier body and which can also be activated by information provided by a control station or another emergency closing assembly. Alternatively, a closure of one device may propagate a signal to close another device or alternatively predetermined conditions detected by one or more sensors 21 may require the closure of more than one closure unit.

In accordance with another exemplary embodiment the emergency closing assembly is configured to operate as a stand-alone unit for a defined time period without human or other intervention.

In accordance with another exemplary embodiment the emergency closing assembly is capable of closing a flow of compressible media, wherein the compressible media (e.g., gas) itself performs/acts like a shock absorber to control the back pressure of the media as the closing assembly is closed off. In accordance with another exemplary embodiment the emergency closing assembly is capable of closing a flow of non-compressible and compressible media by which the energy of the non-compressible and compressible media will be captured by means of a dampening and shock absorbing mechanism provided by a bypass path provided by an alternative pathway fluidly coupled to the closing assembly. In accordance with another exemplary embodiment the emergency closing assembly is capable of closing a flow of non-compressible and compressible media by which the energy of the non-compressible and compressible media is diverted away from the carrier body by means of an alterative fluid pathway. In accordance with another exemplary embodiment the emergency closing assembly is capable of closing a flow of non-compressible and compressible media by which the alterative, dampening and shock absorbing mechanism is preferably placed adjacent to the emergency closing assembly.

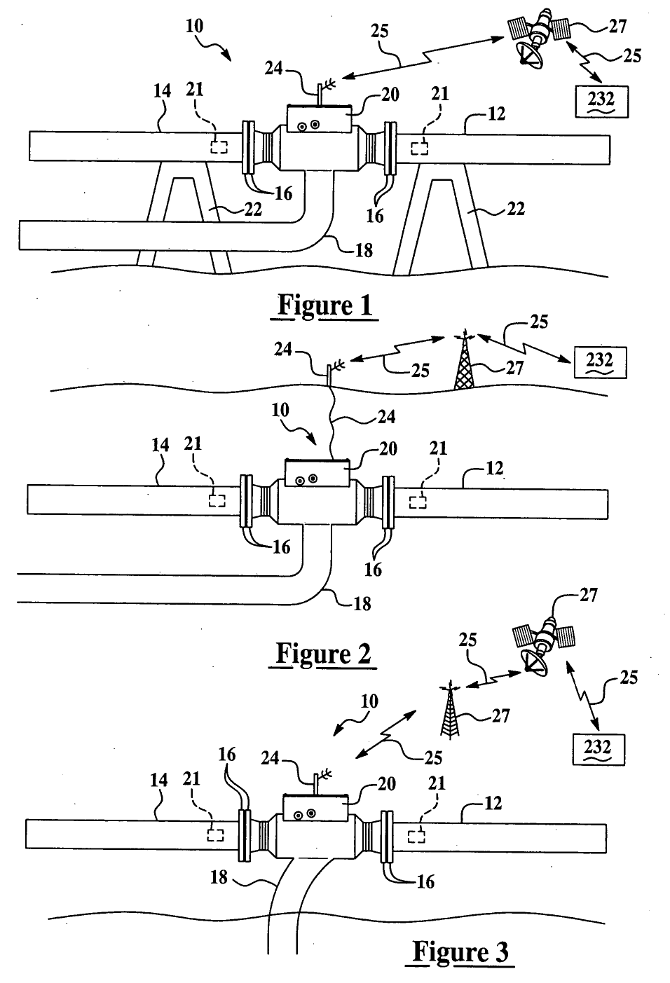

In accordance with an exemplary embodiment of the present invention an emergency closing assembly 10 is illustrated. The emergency closing assembly 10 is coupled between a first pipe 12 and a second pipe 14 via a pair of mounting flanges 16 disposed at either end of the closing assembly. During normal operation fluid flows from pipe 12 to pipe 14 through a path in the closing assembly, the closing assembly also provides a means for diverting fluid flow from either pipe 14 into a bypass pipe 18, which can provide an alternative flow path or act as a dampener to adsorb the energy of the fluid flow as it transitions from a moving state to a static state. In addition, the closing assembly further comprises a control unit 20 for operating a valve closing mechanism. As illustrated in FIG. 1, the system is an above ground system wherein the pipes are supported above ground by structural supports 22.

In accordance with an exemplary embodiment, the control unit of the closing assembly will comprise a microprocessor, microcontroller or other equivalent processing device capable of executing commands of computer readable data or program for executing a control algorithm that controls the operation of the closing assembly. In order to perform the prescribed functions and desired processing, as well as the computations therefore (e.g., the execution of fourier analysis algorithm(s), the control processes prescribed herein, and the like), the controller may include, but not be limited to, a processor(s), computer(s), memory, storage, register(s), timing, interrupt(s), communication interfaces, and input/output signal interfaces, as well as combinations comprising at least one of the foregoing. For example, the controller may include input signal filtering to enable accurate sampling and conversion or acquisitions of such signals from communications interfaces. As described above, exemplary embodiments of the present invention can be implemented through computer-implemented processes and apparatuses for practicing those processes.

In one contemplated embodiment the control unit is adapted to receive signals transmitted thereto from sensors 21 positioned proximate to the control unit as well as transmit outgoing signals via an antenna 24. One non-limiting example of the incoming and outgoing signals would be wireless radio frequency RF transmission. In order to provide an indication of the status of the closure assembly signals 25 are transmitted to a transponder and/or a satellite 27 for operable communication to a central controller 232. In addition, it is also understood that sensors 21 may provide signals to other closure assemblies for interpretation and usage thereof.

Exemplary embodiments of the present invention contemplate a plurality of closing assemblies disposed at various locations of the fluid delivery network, wherein discrete areas of the system (e.g., areas having leaks) may be isolated from the remainder of the system to prevent further leaking. Accordingly, exemplary embodiments of the present invention contemplate a system having a network of sensors each being configured to monitor pressure and/or flow rates to determine whether there is a leak in the system. Once a leak is detected by the sensors an appropriate signal is provided to the closing assembly or assemblies located in the area of the network, which will isolate the leaking pipe from the remainder of the system. Thus, the system is autonomous and can be closed off without human intervention. In accordance with an exemplary embodiment, sensors 21 are positioned to provide signals (either wirelessly or by direct connection) to one or a plurality of control units of closure devices proximate to the sensor or sensors.

In one contemplated embodiment, each control unit will comprise a monitoring and/or diagnostic system comprising a microcontroller or other equivalent processing device capable of executing commands of computer readable data or program for executing a control algorithm that will interpret the signals of the sensors 21 and determine if a closing signal should be sent to the closing assembly as well as determine which closing assemblies to activate (e.g., certain signals may indicate that numerous or other closing assemblies remote from the sensor should be activated). In other words predetermined conditions may be sensed that require the closure of more than one closure assembly.

Thereafter, a signal indicating the status of the closure mechanism (e.g., closed or open) will be provided to a central controller or diagnostic system 232 monitoring the status of the closure mechanisms or selected groups of the closure mechanisms via receipt of signals 25.

One contemplated method for providing this feature is to utilize satellite communications, wherein sensor signals are outputted via an antenna and transceiver (e.g., receiver/ transmitter) to transmitters, transponders and repeaters, as is known in the related arts, and ultimately provided to a receiver of the central monitoring and/or diagnostic system which will receive and interpret the signals received from the closing assembly or alternatively, the signals may be provided from one control unit to another control unit of another closing assembly for transmission to a central monitoring and/or diagnostic systems or a plurality of central monitoring and/or diagnostic systems each of which are in operable communication with each other. In another exemplary embodiment, the signals are provided via a cable or wired network or a combination of a wired and wireless network.

It is understood that contemplated fluid delivery systems may comprise vast networks traveling hundreds of miles thus the number of central monitoring and/or diagnostic systems will of course depend on the size of the network. Examples of networks that are contemplated for use with exemplary embodiments of the present invention are the Alaska pipeline and municipal water and/or gas delivery systems. Thus, control unit 20 via signals from sensors 21 remotely operates the closure device as well as operates as an indication device providing remote status as to the operational status of the closure device.

Referring now to FIG. 2 an example of an underground system is illustrated. Here the control unit is adapted to transmit and receive signals from an antenna 24, which provides a means for the control unit of the closing assembly to receive signals from above the ground as well as transmitting signals from below the ground indicating the status of the closure mechanisms. In other words, the control unit will comprise a receiver and a transmitter to receive and transmit the signals.

Referring now to FIG. 3, an example of another above ground system is illustrated. Here the bypass pipe is configured to provide a fluid path to a bypass conduit located below the ground. Alternatively, the control unit only transmits the signals indicative of activation of the closure device.

In accordance with exemplary embodiments, the closing assembly will comprise a valve or diverting device that is actuated by the control unit when a predetermined event has been detected (e.g., leak or conditions indicating that a failure of the conduit is imminent). Once the control device receives the appropriate signal, a command is given to actuate the valve mechanism, which in one embodiment may be a pyrotechnically activated device. Thereafter, the flow through the closing assembly will now travel into pipe 18. Once flow is diverted to pipe 18 a signal will be sent to the central controller or system indicating that the closure mechanism has been activated. Alternatively, the closure assemblies are configured without pipe 18 and the closure assembly merely provides a means for preventing fluid from flowing through the closure assembly.

One non-limiting example of monitoring the flow of fluid through the closing assembly is to have a plurality of sensors 21 disposed within the system, wherein the pressure and/or flow rate of the fluid is monitored at different locations of the system. Thus, it is possible to detect the approximate location of the leak and activate the closing assemblies disposed upstream and, if necessary, down stream (e.g., prevent back flow or provide a bypass path). In addition and in one alternative embodiment, the sensors are also positioned to detect flow in the bypass pipe thus, indicating that the closure mechanism has been closed and flow has been diverted. Thereafter, a signal (either wirelessly or via direct electrical communication) is provided to the central control system indicating the activation of the closure system.

Non-limiting examples of sensors 21 include pressure sensors, temperature sensors configured to detect the external or internal temperature of conduit, velocity sensors configured to detect the velocity of media traveling in the conduit; vibration sensors; noise sensors; density sensors configured to detect the density of the media in the conduit; odor sensors; chemical sensors configured to detect the chemical composition of media flowing in the conduit; or any combination thereof. Sensors for detecting the aforesaid physical conditions are commercially available and are in operable communication with the control unit to provide signals indicative of the detected condition to the control algorithm of the control unit.

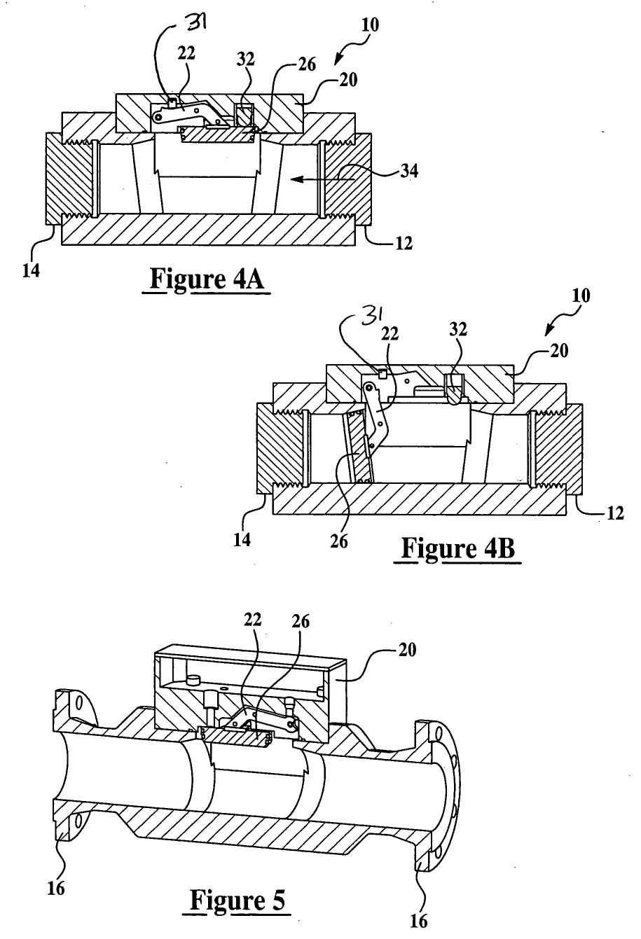

FIGS. 4A and 4B illustrate an exemplary embodiment of the present invention in an opened and closed position. In this embodiment, a sealing member 26 is movably mounted to the control unit via an arm 28. Control assembly 10 is positioned such that the sealing member 26 moves into the fluid path illustrated by arrow 30.

In order to move the sealing member into the closing position an actuating device 32 provides a means for moving the sealing member into the closing position. In accordance with an exemplary embodiment, actuating device 32 is a pyrotechnically activated squib coupled to a microprocessor unit configured to receive and provide signals. In one embodiment, device 32 will comprise a projectile that is fired to urge sealing member 26 into the closed position. Sealing member 26 and arm 30 may also be configured to operate with a locking mechanism, wherein the sealing member and the arm are locked into the open position. Furthermore, a sensor 31 configured to detect the movement or actuation of the arm is provided. In one non-limiting example sensor 31 is a pressure switch that provides a signal when the arm has pivoted to a deployed position. Thus, sensor 31 provides a signal of a locked position that is provided to a control unit or indication device configured to provide signals to the system indicating that a closing assembly has been closed. This is particularly useful in remote applications wherein the closing mechanism is independently operated (e.g., local sensors detect leak or other conditions that requires closing of the device, thereafter a closure signal is sent to the central control system to indicate that the closing mechanism has been activated). In yet another alternative, and where feasible due to back pressures in the system the closing assembly can include a retraction mechanism for reopening the closing assembly in the event of a repair of the leak or a signal indicating that the flow rates or pressures are back in the operating ranges. In this embodiment opening signals are transmitted to the control unit from either sensors 21, 31 or the central controller 232. FIGS. 5 and 6 also illustrate portions of the closing assembly of FIGS. 4A and 4B.

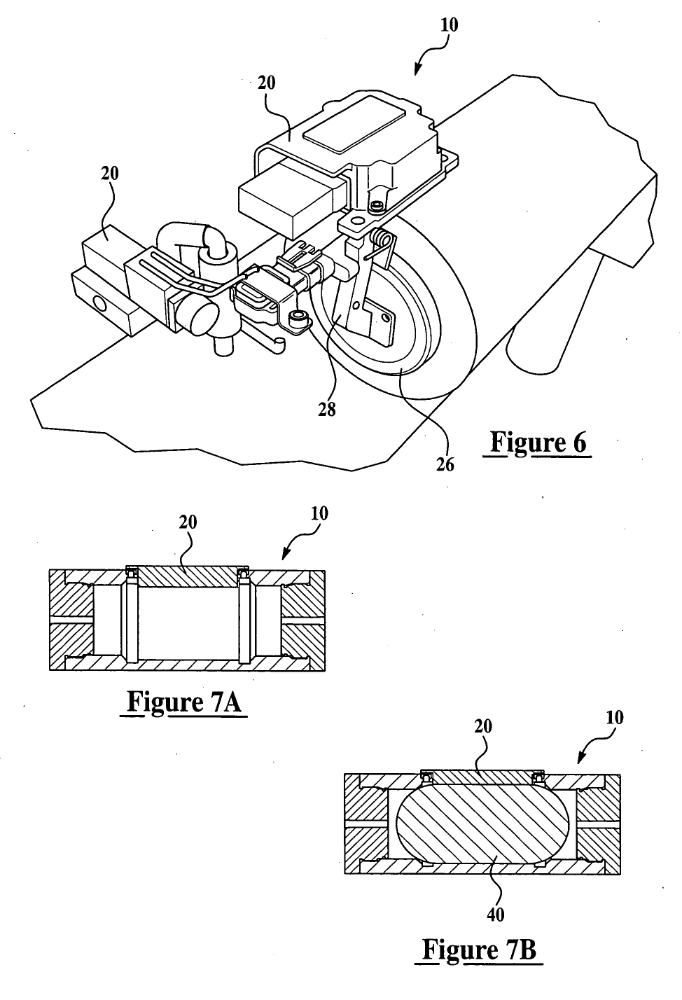

Referring now to FIGS. 7A and 7B an alternative closing assembly is illustrated. Here an inflatable member 40 is provided for use as the means for closing off the fluid pathway. In this embodiment, the inflatable member is deployed to effectively block off the fluid path of the closing assembly when a leak is detected. Operation and/or activation of this device would be similar to deployable airbags of vehicles wherein the inflatable member is inflated with an inflator that releases an amount of inflation gas into the inflatable member. In one contemplated embodiment, the inflator releases the inflation gas upon receipt of an activation signal received from a sensor positioned to detect a predetermined event (e.g., drop in flow or variation in flow that would indicate a condition requiring closure of the closure device). Thus, once inflated the inflatable member provides a means for blocking off the fluid path.

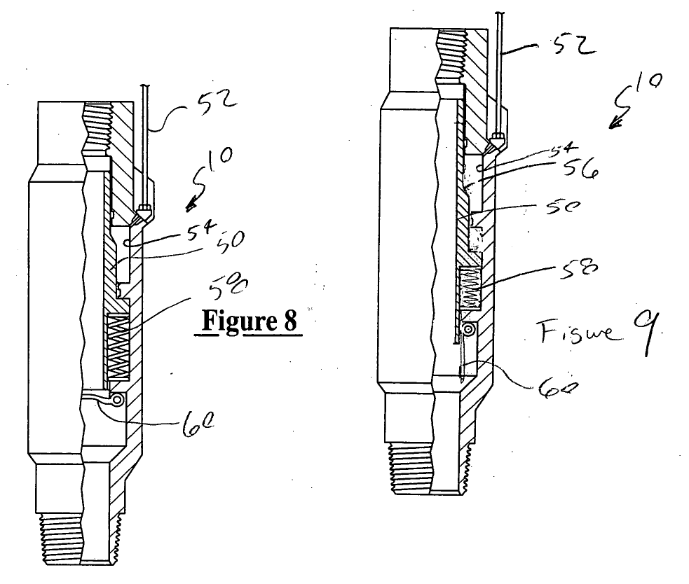

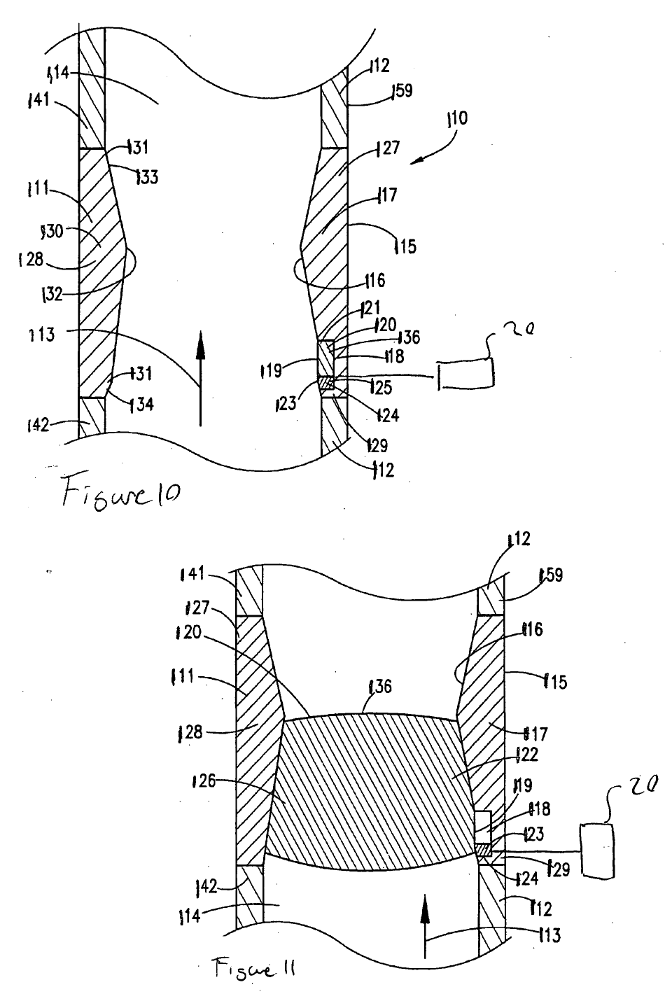

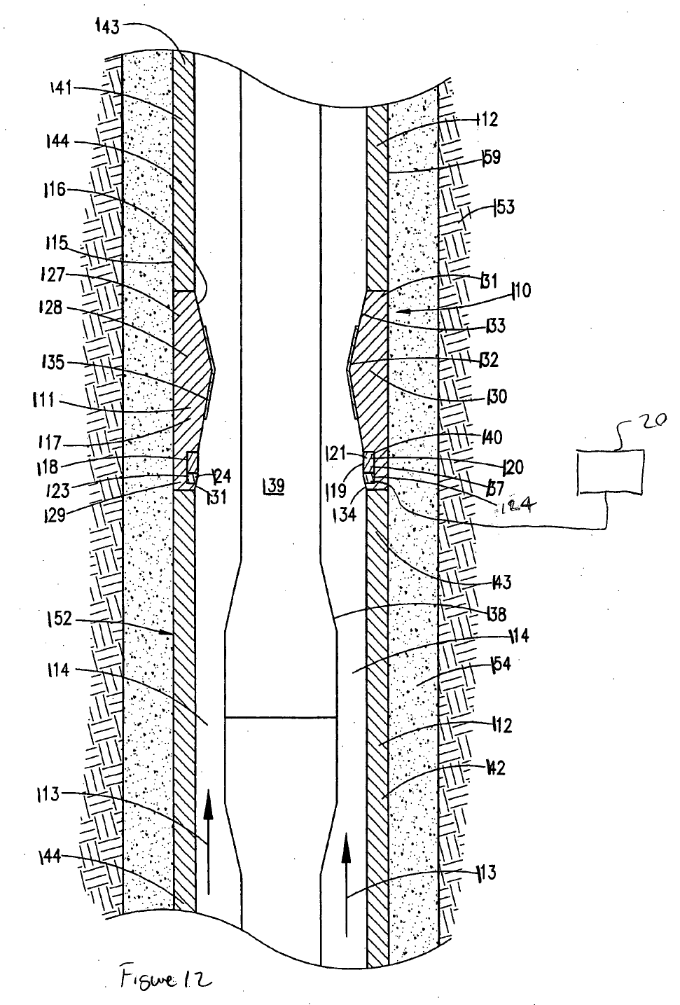

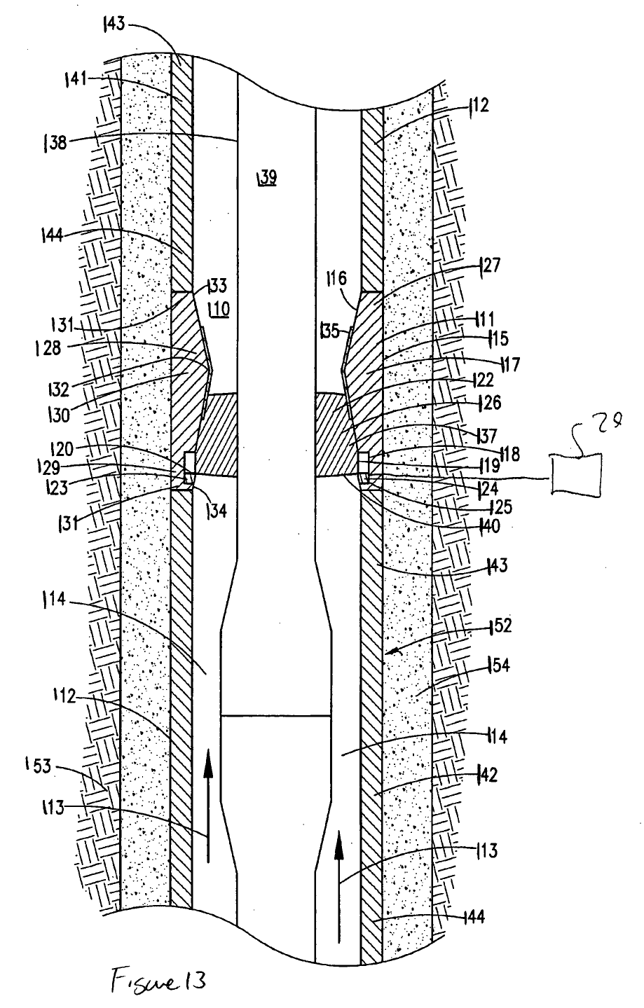

FIGS. 8 and 9 illustrate alternative methods for providing a means for closing the fluid path through the closing assembly in a producing well. Referring now to FIGS. 8 and 9 an open and closed position of the closing assembly is illustrated. Here the closing assembly comprises a linearly activated control sleeve 50 that is slidably received within the closing assembly. In order to actuate the sleeve from a closed position (FIG. 8) to an open position (FIG. 9) and vice versa, a hydraulic fluid supply line 52 provides hydraulic fluid to a cavity 54 wherein the fluid will act upon a chamfered surface 56 of the sleeve in order to cause movement of the sleeve within the device. In addition, a biasing spring 58 is provided to urge the sleeve back to the position illustrated in FIG. 8 once the hydraulic force is removed.

As the sleeve moves from the position illustrated in FIG. 8 to 9, a flapper or conduit covering item 60 is moved from a blocking position to an unblocking position and vice versa. In one embodiment, the flapper is spring biased to return to the position illustrated in FIG. 8 as the sleeve moves away from the flapper. Of course and as an alternative embodiment, the closure device can be reconfigured to close the flapper as the sleeve is moved by the hydraulic fluid.

In one embodiment, and under normal operating conditions a hydraulic supply and therefore hydraulic pressure is provided consistently. If the hydraulic pressure gets lost for example due to electrical power loss or due to a catastrophic incident that removes the hydraulic line, the sleeve shifts up and the flapper closes the tubing, thus stopping the carbon content from flowing. In accordance with an exemplary embodiment, the loss of hydraulic fluid may be caused by an appropriate signal from a sensor 21 positioned to detect a predetermined condition requiring the closure of the closure device.

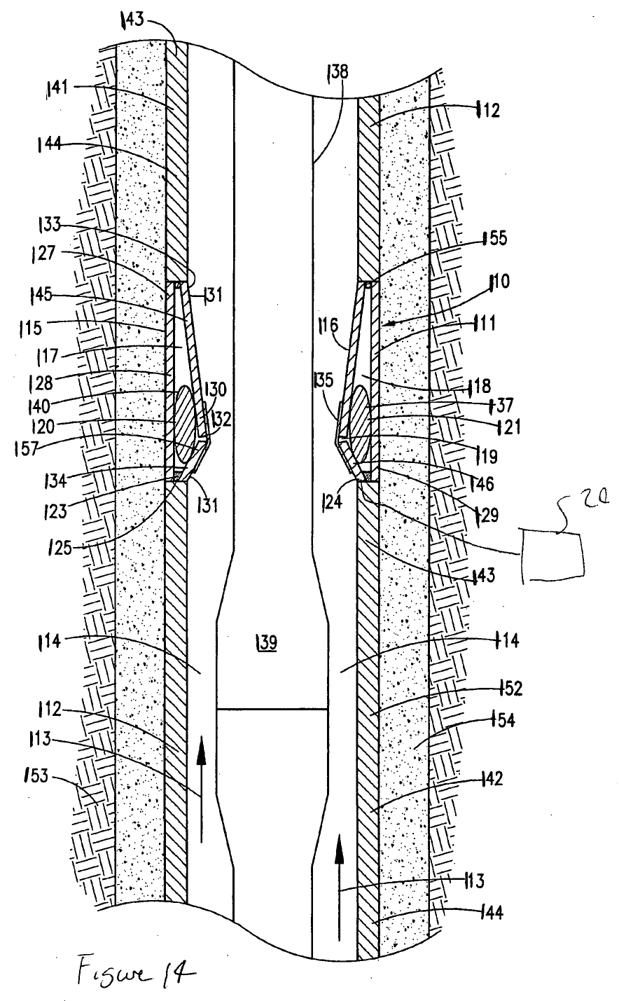

Referring now to FIGS. 10-19 an example of one type of closing mechanism contemplated for use with exemplary embodiment of the present invention is illustrated. The mechanism of FIGS. 10-19 is also described in U.S. Pat. No. 6,966,373, the contents of which are incorporated herein by reference thereto.

As illustrated in FIG. 10, an inflatable sealing assembly or closure mechanism 110 is provided. In an exemplary embodiment closure mechanism 110 is constructed with a housing 111. Housing 111 preferably is capable of being integrated with a tubular conduit 112 to permit an unobstructed flow of media 113 through a flow bore 114 in the tubular conduit 112. Housing 111 may be made of any structurally rigid material. In one embodiment, housing 111 is constructed of steel. Media 113 may be a variety of different materials such as fluid (water, oil, acids, air and the like and combinations thereof) or compressible media (natural gas, nitrogen, and the like and combinations thereof) or slurries with particles (drilling fluid, ore slurry, and the like and combinations thereof).

As shown in FIG. 10, housing 111 includes outer wall 115, inner wall 116, and an interior 117 located between outer wall 115 and inner wall 116. In an exemplary embodiment, inner wall 116 defines part of flow bore 114 in tubular conduit 112 when inflatable sealing assembly 110 is integrated with tubular conduit 112.

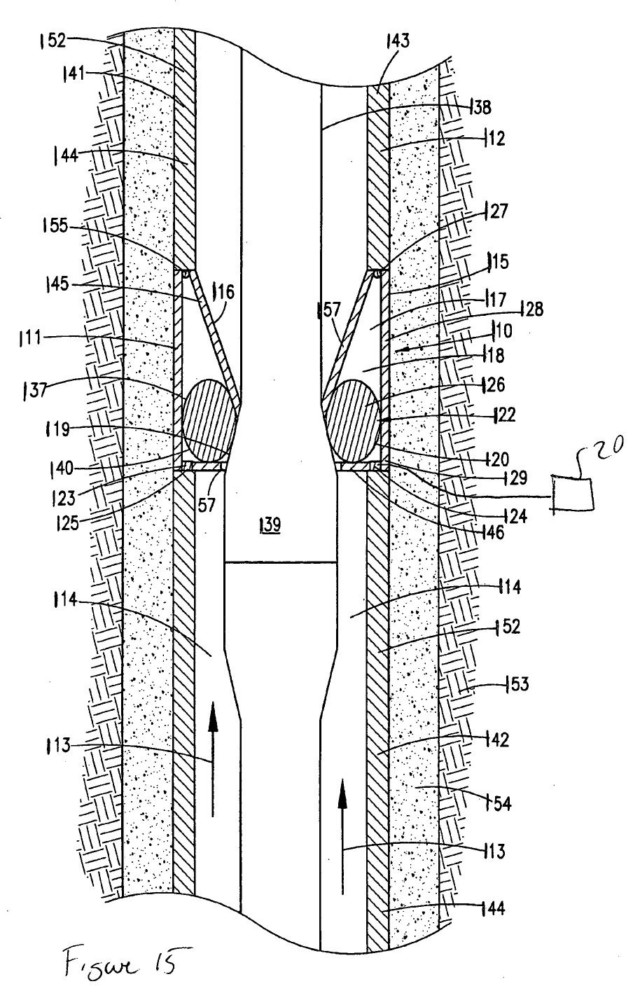

FIG. 12 illustrates that housing 111 may be cylindrical and may have a top section 127, a central section 128, and a bottom section 129. In an exemplary embodiment, central section 128 has a width 130 which is greater than a width 131 of each of top section 127 and bottom section 129. Thus, inner wall 116 of housing 111 is tapered from central section 128 (e.g., from portion 132) to each of portion 133 of top section 127 and portion 134 of bottom section 129. This tapering of inner wall 116 acts to protect inflatable sealing assembly 110 when integrated in tubular conduit 112 (particularly when protective plate 135 as described below is used therewith) and acts to guide longitudinally extending object 139 (e.g., a work string) which may be run through inflatable sealing assembly 110 when integrated in tubular conduit 112.

In exemplary embodiments, inflatable sealing assembly 110 may be integrated with tubular conduit 112 wherein tubular conduit 112 may include at least a first tubular section 141 and a second tubular section 142. First and second tubular sections 141, 142 each may have top end 143 and bottom end 144. In an exemplary embodiment, top section 127 of housing 111 is connected to a bottom end 144 of first tubular section 141 and bottom section 129 of housing 111 is connected to top end 143 of second tubular section 142. More particularly, top section 127 of housing 111 is threadedly connected to bottom end 144 of first tubular section 141 and bottom section 129 of housing 111 is threadedly connected to top end 143 of second tubular section 142.

FIG. 12 illustrates that inner wall 116 of housing 111 may include protective plate 135 that is structurally strengthened to protect inner wall 116 from damage caused by running or positioning of longitudinally extending object 139 (e.g., work string) in tubular conduit 112 when inflatable sealing assembly 110 is integrated therewith. Protective plate 135, which in one embodiment is a steel plate, which may be either incorporated into inner wall 116 or affixed thereto by welding or other suitable bonding technique.

Referring back now to FIG. 10, a compartment 118 is provided in an interior 117 of housing 111, in an exemplary embodiment, compartment 118 has an opening 119 that provides access to flow bore 114 of tubular conduit 112 when inflatable sealing assembly 110 is integrated with tubular conduit 112. Compartment 118 is positioned in bottom section 129 of housing 111 within interior 117 as shown in FIGS. 10-12.

The size of compartment 118 may vary depending on the size of inflatable sealing means 120 that is to be stored therein. In an exemplary embodiment, the size of compartment 118 is such that it accommodates inflatable sealing means 120 in non-deployed position 121 while leaving sufficient space so that inflatable sealing means 120 is able to be deployed from compartment 118.

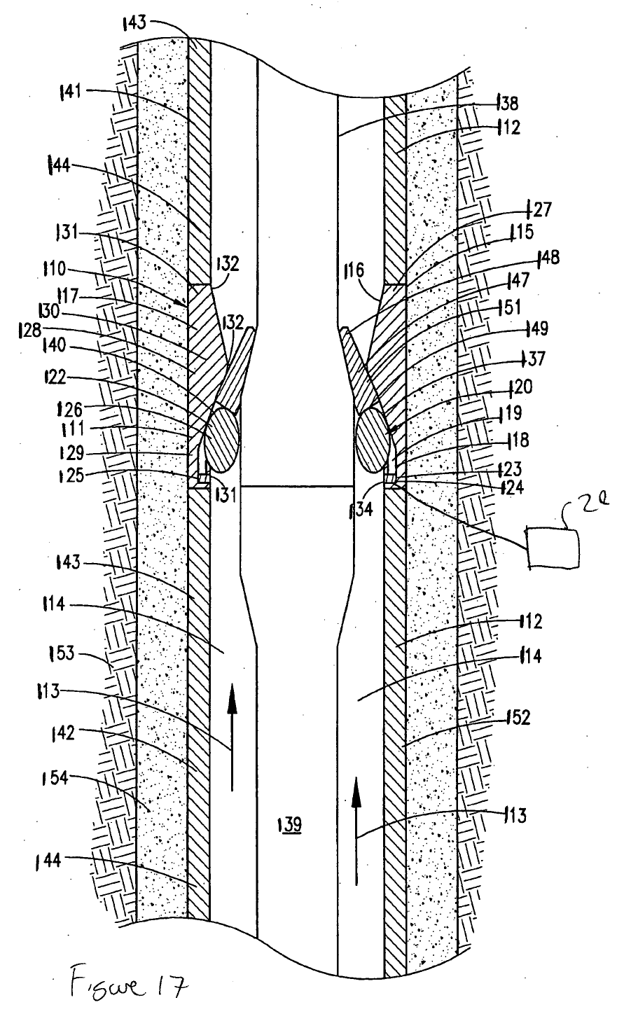

Compartment 118 may be a cutout in interior 117 of housing 111 as shown in FIGS. 10-12 and 16-19. Alternatively as shown in FIGS. 14 and 15, compartment 118 may comprise all or part of interior 117 of housing 111. It is to be understood that interior 117 of housing 111 shown in FIGS. 14 and 15 could be modified to include a separate compartment 118 (not shown) which may be formed in part from metal or plastic plates perpendicularly affixed to outer wall 115 within interior 117 in such a manner that enables inner wall 116 to partly disengage in order to provide opening 119 so that inflatable sealing means 120 may be deployed.

FIGS. 10 and 11 illustrate that housing 111 may include inflatable sealing means 120. In an exemplary embodiment, inflatable sealing means 120 has a non-deployed position 121 (FIG. 10) and a deployed position 122 (FIG. 11). When in non-deployed position 121, it is preferred that inflatable sealing means 120 is stored substantially within compartment 118.

In one embodiment, inflatable sealing means 120 is an air bag or inflatable cushion 136. Air bag 136 may be made of any material that is capable of being folded so that it can be stored in compartment 118 (which may be of limited space) and thereafter inflated upon activation of inflating means 120. The material used to construct air bag 136 must also be able to contain gas 126 which inflates air bag 136 for an extended period of time in order to maintain the seal formed by air bag 136 when it is inflated in flow bore 114.

In an exemplary embodiment, the material used to construct air bag 136 is relatively thin, nylon fabric or other woven fabric which is able to withstand the physical forces that may be present in tubular conduit 112, as for example hydrocarbon temperature and pressure. A rubber or rubber like material could also be used to form air bag 136 so long as it is capable of folding for storage in compartment 118 and inflating when gas 126 is introduced therein. The size and shape of inflatable sealing means 120 and in particular air bag 136 is dependent on the area or diameter of the specific flow bore 114 which is to be sealed.

Because inflatable sealing means 120 is inflatable and elastic, inflatable sealing means 120 is able to conform to the shape of the objects in flow bore 114 or the shape of the cross sectional area of flow bore 114 (which can be any shape such as circular, square, spline shaped, etc.) and thereby seal flow bore 114. Thus, inflatable sealing means 120 is adaptable and able to seal all manner of tubulars regardless of their internal shapes or what objects are positioned therein.

FIGS. 10 and 11 also demonstrate that housing 111 may include an inflating means 123. In an exemplary embodiment, inflating means 123 is capable of deploying inflatable sealing means 120 from non-deployed position 121 to deployed position 122. Inflating means 123 is in one embodiment positioned in interior 117 of housing 111, preferably in bottom section 129. More particularly, inflating means 123 is operatively connected to inflatable sealing means 120 so that when activated it will cause inflatable sealing means 120 to inflate and seal flow bore 114 in tubular conduit 112.

Inflating means 123 may be any device that is capable of inflating inflatable sealing means 120. Inflating means 123 preferably is any type of device which is capable of introducing gas 126 into inflatable sealing means 120. For example, inflating means 123 may be compressed air or other compressed gas 126 which is stored under pressure and then discharged into inflatable sealing means 120 when a sensor 124 detects a physical condition which signifies that sealing of flow bore 114 is necessary. To open the reservoir housing compressed gas 126, inflating means 123 may include a diaphragm separating compressed gas 126 from inflatable sealing means 120 that may be ruptured by mechanical techniques upon activation by sensor 124.

Inflating means 123 may for example be a gas generator having a rapidly burning propellant composition stored therein for producing substantial volumes of gas 126 which is then directed into inflatable sealing means 120. Gas generators of the type that may be used in the present invention generally use solid fuel gas generating compositions and generally include an outer metal housing, a gas generating composition located within the housing, an igniter to ignite the gas generating composition in response to a signal received from a sensor (e.g., sensor 124 positioned at a location removed from the generator) and, if necessary, a device to filter and cool gas 126 before gas 126 is discharged into inflatable sealing means 120.

In addition and in accordance with an exemplary embodiment of the present invention, sensor or sensing means 124 is also in operable communication with control unit 20 of the closure assembly wherein and upon activation of the closure assembly a signal is also generated to the control unit indicating that the closure assembly of the device has been activated.

Thereafter, the microcontroller of the control unit will send a signal 25 to the central controller indicating that this particular closure assembly has been activated. Alternatively sensor or sensing means 124 will send the signal to an operating program of the control unit 20 wherein the control unit determines whether to activate the closing device of the closure assembly and upon activation of the closing assembly, the control unit via the transmitter or transceiver sends signal 25 indicating that the closure assembly has been activated.

It is to be understood that various gas generators may be used as inflating means 123 so long as they produce a sufficient volume of gas 126 to inflate and deploy inflatable sealing means 120. Also various gas compositions may be used. In an exemplary embodiment, the gas generating compositions used with inflating means 123 including for example reacting sodium azide (NaN₃) with potassium nitrate (KNO₃) to produce nitrogen gas.

As also shown in FIGS. 10 and 11, sensor means 124 may be operatively connected to inflating means 123. In an exemplary embodiment, sensor means 124 is capable of detecting a physical condition affecting tubular conduit 112 and upon detection of the physical condition, of activating inflating means 123 to inflate and deploy inflatable sealing means 120.

Sensor means 124 may be positioned anywhere in tubular conduit 112 so long as sensor means 124 is capable of detecting the physical condition affecting tubular conduit 112. For example, sensor means 124 may in part be positioned on or in tubular conduit 112 and more preferably on or near an external surface 159 of tubular conduit 112 particularly when sensor means 124 is designed to detect a physical condition affecting tubular conduit 112 or affecting external surface 159 of tubular conduit 112. Alternatively, sensor means 124 may be positioned in part on or near housing 111 of inflatable sealing means 110 particularly when sensor means 124 is designed to detect a physical condition within flow bore 114. In an exemplary embodiment, sensor means 124 may be positioned at least in part within interior 117 of housing 111. Sensor means 124 automatically activates inflating means 123 upon detection of the physical condition affecting tubular conduit 112.

It is to be understood that sensor means 124 may detect a physical condition affecting external surface 159 of tubular conduit 112 or affecting flow bore 114 of tubular conduit 112 or both. It should also be understood that more than one sensor means 124 may be provided as part of inflatable sealing assembly 110 which may detect the same physical condition affecting tubular conduit 112 or one or more different physical conditions affecting tubular conduit 112. Also, one sensor means 124 may be provided that has the capability to detect more than one physical condition affecting tubular conduit 112 and/or physical conditions affecting tubular conduit 112 that may be manifested in various locations on or in tubular conduit 112, as for example, external surface 159 or in flow bore 114.

As described, sensor means 124 may be any sensor that detects one or more specific physical conditions in or affecting tubular conduit 112. The physical condition affecting tubular conduit 112 that may be detected by sensor means 124 includes any physical condition indicative of potential harm or destruction to tubular conduit 112. For example, sensor means 124 may detect physical conditions such as the following: pressure exerted on or inside tubular conduit 112; the velocity of media 113 traveling in flow bore 114; the external or internal temperature of tubular conduit 112 or of media 113 in flow bore 114; the vibration of tubular conduit 112; the noise around or in tubular conduit 112; the density of tubular conduit 112 or of media 113 in tubular conduit 112; the odor or color of media 113 in flow bore 114; the chemical composition of media 113 in flow bore 114; or any combination thereof. Sensors for detecting the aforesaid physical conditions are commercially available.

The physical condition detected by sensor means 124 is preferably a change in a physical condition affecting tubular conduit 112 or more preferably a change in physical condition affecting or arising in or from flow bore 114 or media 113 in flow bore 114. In an exemplary embodiment, the physical condition detected by sensor 124 is a change in fluid pressure within flow bore 114 and more preferably in media 113. In order to detect the fluid pressure, sensor means 124 may be any type of sensor that is capable of detecting fluid pressure, as for example a pressure switch. Sensor means 124 preferably detects and activates inflating means 123 when a pre-selected fluid pressure is reached in flow bore 114. For example, when the fluid pressure in flow bore 114 reaches the pre-selected threshold level determinative of a physical condition necessitating the sealing of flow bore 114 (e.g., when fluid pressure is such that it may signal that blowout conditions exist), a switch such as a snap-acting diaphragm in sensor 124 is initiated, as for example by having the snap-acting diaphragm reverse its curvature, which opens or closes a set of electrical contacts causing inflating means 123 to inflate and deploy inflatable sealing means 120.

It is to be understood that when inflatable sealing means 120 is inflated and deployed it may be either attached or secured to housing 111 or it may be disassociated or disengaged from housing 111. If disassociated or disengaged from housing 111, inflatable sealing means 120 as deployed may be located within flow bore 114 adjacent to or near housing 111 as shown in FIG. 11. FIG. 11 also shows that tubular conduit 112 has an area of reduced diameter created by the integration of inflatable sealing assembly 110 with tubular conduit 112; the reduced diameter area being formed in particular by the tapering of inner wall 116 of housing 111. Thus, the tapered inner wall 116, having established an area in tubular conduit 112 of reduced diameter, holds and assists inflatable sealing means 120 to seal flow bore 114 when in deployed position 122. In an embodiment not shown, inflatable sealing means 120 may move within flow bore 114 when it disassociates or disengages from housing 111. This would be desirable if the intent is to seal flow bore 114 at a location that is not in close proximity to housing 111. For example, inflated and deployed inflatable sealing means 120 may move within flow bore 114 (e.g., by force of media 113) to a different location or area of tubular conduit 112 where inflatable sealing means 120 seals flow bore 114 in tubular conduit 112 at said different location or area. In an exemplary embodiment, the different area or location within tubular conduit 112 has a reduced diameter. In an exemplary embodiment, inflated and deployed inflatable sealing means 120 is larger in size than the area of reduced diameter so that inflatable sealing means 120 comes to rest or abuts against the area of reduced diameter and plug and seal flow bore 114 at this area.

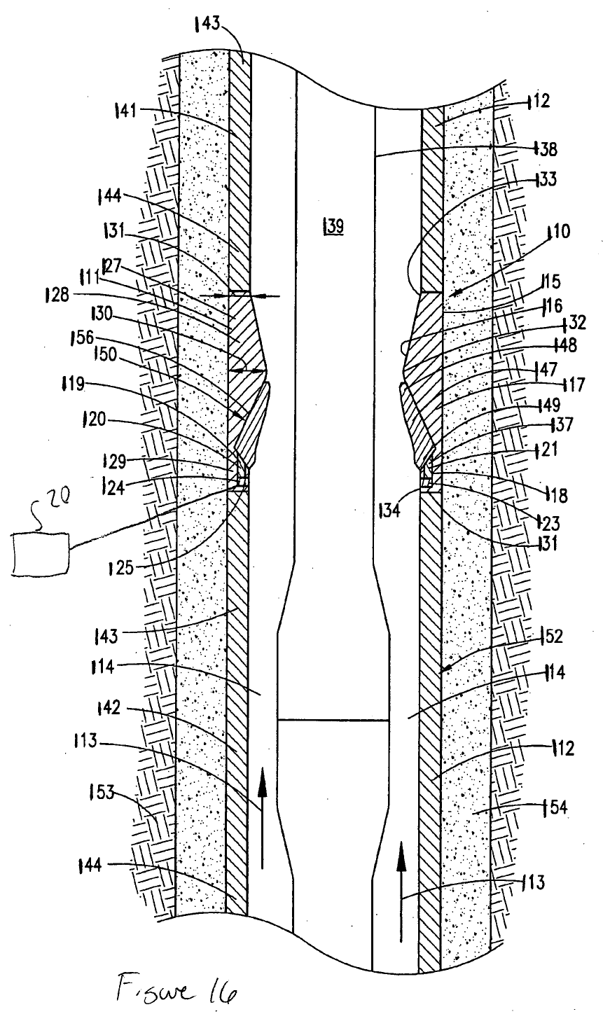

An alternative embodiment of inflatable sealing assembly 110 of the present invention is shown in FIGS. 12 and 13. In this embodiment, compartment 118 extends substantially around the circumference of cylindrical housing 111 and more preferably substantially around the circumference of inner wall 116 of cylindrical housing 111. Inflatable sealing assembly 110 is provided with an inflatable sealing ring 137. In non-deployed position 121, inflatable sealing ring 137 is stored substantially within compartment 118.

Inflatable sealing ring 137 is designed so that when it is in deployed position 122 inflatable sealing ring 137 is inflated and compresses against an outer surface 138 of a longitudinally extending object 139 (e.g., a work string) which may be positioned within flow bore 114. Upon inflation and deployment of inflatable sealing ring 137, inflatable sealing ring 137 seals flow bore 114 in tubular conduit 112 between inner wall 116 of cylindrical housing 111 and outer surface 138 of object 139. In an exemplary embodiment, inflatable sealing ring 137 is in the form of donut-shaped air bag 140. Donut-shaped air bag 140 may have a central opening which accommodates object 139 that may be positioned in flow bore 114.

With reference to FIGS. 14 and 15, inner wall 116 of cylindrical housing 111 may provide a cover for an opening 119 in compartment 118 when inflatable sealing ring 137 is in non-deployed position 121. In an exemplary embodiment, inner wall 116 includes at least a first section 145 and a second section 146. More particularly, sections 145 and 146 each have an end 157 which are capable of being detachably connected together. Deployment of inflatable sealing ring 137 may cause ends 157 to detach and expose opening 119 in compartment 118 so as to permit inflatable sealing ring 137 to inflate and deploy in flow bore 114 as shown in FIG. 15.

FIG. 15 also shows that when inflatable sealing ring 137 is deployed, first section 145 of inner wall 116 may be swung about a pivot means 155 so that end 157 of first section 145 abuts outer surface 138 of longitudinally extending object 139, which may provide further sealing of flow bore 114 and which may provide assistance in changing (stopping) of movement of longitudinally extending object 139. Second section 146 may move in the opposite direction from first section 145 and may come to rest at a position perpendicular to outer wall 115 of cylindrical housing 111.

In this position, second section 146 may provide support for a portion of inflatable sealing ring 137. Pivot means 155 may be located in an interior 117 at a top section 127. Pivot means 155 may be any device which assists in the pivoting of first section 145 when inflatable sealing ring 137 is inflated and deployed to deployed position 122. Although not shown, second section 146 may have associated therewith a pivot device which assists in the pivoting or movement of second section 146.

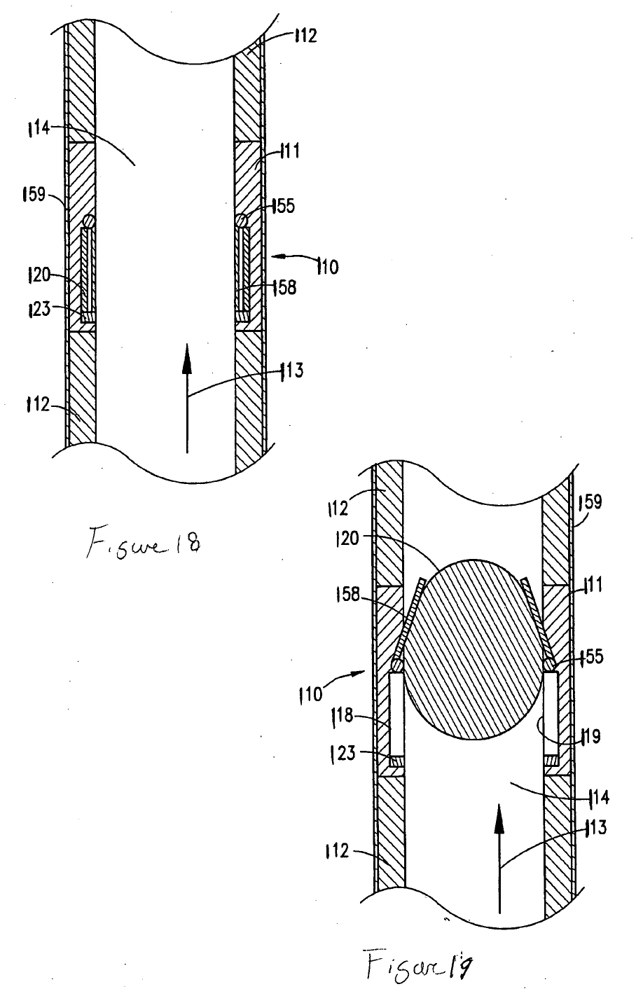

FIGS. 16 and 17 illustrate another preferred embodiment of inflatable sealing assembly 110. Cylindrical housing 111 preferably includes a slidable wedge-shaped member 147. Slidable wedge-shaped member 147 may be positioned on inner wall 116 of cylindrical housing 111. Slidable wedge-shaped member 147 preferably includes a first end 148 and a second end 149. When inflatable sealing ring 137 is in a non-deployed position 121, a second end 149 of slidable wedge-shaped member 147 provides a cover for opening 119 in compartment 118. In this position, slidable wedge-shaped member 147 is in a closed position 150.

In an exemplary embodiment, slidable wedge-shaped member 147 is operatively connected to inflatable sealing ring 137 such that when inflatable sealing ring 137 is inflated and deployed, second end 149 of slidable wedge-shaped member 147 is positioned away from opening 119 in compartment 118 with first end 148 of slidable wedge-shaped member 147 abutted or wedged against outer surface 138 of longitudinally extending object 139 thus mechanically restraining longitudinally extending object 139 in position. In this position, slidable wedge-shaped member 147 is in an open active position 151.

When slidable wedge-shaped member 147 transitions from closed position 150 to open position 151, slidable wedge-shaped member 147 preferably slides on tapered section 156 of inner wall 116, in an exemplary embodiment, tongue and groove, dovetail, or other similar mechanisms are provided in slidable wedge-shaped member 147 and a tapered section 156 to ensure proper contact and sliding action between slidable wedge-shaped member 147 and tapered section 156.

In one non-limiting exemplary embodiment, slidable wedge-shaped member 147 is made in whole or in part of a deformable or compressible material such rubber or a rubber-like material so that when slidable wedge-shaped member 147 is in open position 151, second end 149 of slidable wedge-shaped member 147 forms a seal around outer surface 138 of longitudinally extending object 139.

As shown in FIGS. 18 and 19, section 158 of inner wall 116 of housing 111 is movable about pivot means 155 so that section 158 acts as a flapper mechanism covering opening 119 in compartment 118 when inflatable sealing means 120 is in non-deployed position 121 and moving away from opening 119 when inflatable sealing means 120 is in deployed position 122. By moving away from opening 119, section 158 permits deployment of inflatable sealing means 120. When section 158 of inner wall 116 is moved away from opening 119 and is in its fully extended position, section 158 acts to assist and hold inflatable sealing means 120 in sealing engagement to plug and seal flow bore 114 by providing an area and reduced diameter in flow bore 114.

The use of inflating sealing assembly 110 to seal flow bore 114 will now be described. Inflatable sealing assembly 110 is provided and integrated with tubular conduit 112. In an exemplary embodiment, a top section 127 of housing 111 is connected (preferably by threaded connection) to bottom end 144 of first tubular section 141 and bottom section 129 of housing 111 is connected (preferably by threaded connection) to top end 143 of second tubular section 142. Tubular conduit 112 with inflating sealing assembly 110 integrated therewith may be used to transport materials such as media or fluid 113 through flow bore 114.

It is to be understood that inflatable sealing means 120 may be integrated with tubular conduit 112 in various other ways. For example, inflatable sealing assembly may be positioned and held in place on the inside of tubular conduit 112, preferably in a reduced inner cross section area of tubular conduit 112. Inflatable sealing assembly 110 may be held in place by any positioning or fixation device such as ropes or other mechanisms which tie or detachably affix inflatable sealing assembly 110 to the inside of tubular conduit 112. Mechanical devices such as flappers may cover inflatable sealing assembly 110 and then extend when inflatable sealing means 120 is inflated and deployed.

With the flow of media 113 through flow bore 114 of tubular conduit 112, sensor means 124 is allowed or permitted to detect a physical condition affecting tubular conduit 112. In an exemplary embodiment, the physical condition detected by sensor means 124 is a physical condition in media 113 or more preferably a change in physical condition affecting tubular conduit 112 and/or a change in physical condition in flow bore 114 or of media 113. Such physical conditions may be pressure change or differential pressure, speed or velocity change, temperature change, vibration change, noise change, color change, odor change, density change, chemical composition change, or any combination of the aforesaid.

Upon detection of the physical condition or change in physical condition, sensor means 124 activates inflating means 123 which then causes the inflation and deployment of inflatable sealing means 120 from non-deployed position 121 to deployed position 122. In deployed position 122, inflatable sealing means 120 forms a seal in flow bore 114 to prevent the passage of media 113 past the point where flow bore 114 is sealed by inflatable sealing means 120.

In the preferred embodiment of the method of the present invention, sensor means 124 automatically activates inflating means 123 upon detection of the physical condition or change in physical condition which may be a pre-selected physical condition or change in physical condition such as fluid pressure. Inflating means 123 is preferably any device which produces gas 126 in sufficient volume to inflate and deploy inflatable sealing means 120. Inflatable sealing means 120 is preferably in the form of air bag 136 when no object 139 is positioned in flow bore 114. Inflatable sealing ring 137 in the form of donut-shaped air bag 140 is preferably used when object 139 is positioned in flow bore 114.

Inflatable sealing assembly 110 may be used in pipelines such as water pipelines, gas pipelines, sewage pipelines, or the like. Inflatable sealing assembly 110 may be used in chemical plants, power plants, or nuclear plants. Inflatable sealing assembly 110 may also be used in oil and gas applications such as in the upstream market (drilling and completion of wells) and in the downstream market (hydrocarbon transportation and distribution).

As shown in FIGS. 12-17, inflatable sealing assembly 110 may be used as a blowout preventer. In this application, inflatable sealing assembly 110 is integrated with a well casing 152. Well casing 152 is positioned downhole as shown for example in FIG. 12, which reveals the placement of well casing 152 in association with cement 154 and well formation 153. Sensor means 124 would be preset to detect and activate (preferably automatically) inflating means 123 upon detection of a pre-selected fluid pressure or a change in fluid pressure signifying that blowout conditions exist in flow bore 114.

Upon detection of the fluid pressure or change in fluid pressure, sensor means 124, as previously described herein, would activate inflating means 123 which in turn would cause the inflation and deployment of inflatable sealing ring 137 from non-deployed position 121 to deployed position 122. In deployed position 122, inflatable sealing ring 137 would form a seal between inner wall 116 of housing 111 and outer surface 138 of object 139 (object 139 being for example a work string).

In one exemplary embodiment, inflatable sealing means 120 is able to be deflated when for example the physical conditions in flow bore 114 which necessitated sealing flow bore 114 have dissipated. Deflating devices (such as valves) may be incorporated into inflatable sealing means 120 to cause deflation when activated or external mechanisms may be employed to deflate inflatable sealing means 120, as for example by puncturing inflatable sealing means 120.

In the application where inflatable sealing assembly 110 is used as a blowout preventer, inflatable sealing ring 137 will maintain a deployed state until such time that it is desired to deflate inflatable sealing ring 137. Deflation of inflatable sealing ring 137 may occur in a number of ways. For example, inflatable sealing ring 137 may be physically ruptured by a tool that is passed down through flow bore 114 from the well surface or through object 139. Additionally, other mechanisms can be incorporated into inflatable sealing assembly 110 which may cause deflation of inflatable sealing ring 137. For example, a release valve may be included and operatively connected to inflatable sealing ring 137 which when activated will cause the release of gas 126 within inflatable sealing ring 137 and thereby deflate the same.

It is to be understood that two or more inflatable sealing assemblies 110 may be integrated with tubular conduit 112 to provide a series of spaced-apart inflatable sealing assemblies 110 within tubular conduit 112. The use of multiple inflatable sealing assemblies 110 may be done in order to provide a backup sealing mechanism in case of malfunction.

Inflatable sealing assembly 110 may also function to activate other moving mechanisms which provide sealing of flow bore 114 in tubular conduit 112. For example, inflating means 123 and/or inflatable sealing means 120 may cause activation of other mechanical sealing mechanisms such as rams, flappers, or the like which assist in the sealing of flow bore 114. The shut-off valves in pipelines and mechanical blowout preventers which are presently in use as sealing mechanisms are slow; the inflatable sealing assembly 110 of the present invention seals flow bore 114 rapidly thus preventing leaking of media 113 or potential erosion of the mechanical sealing mechanism.

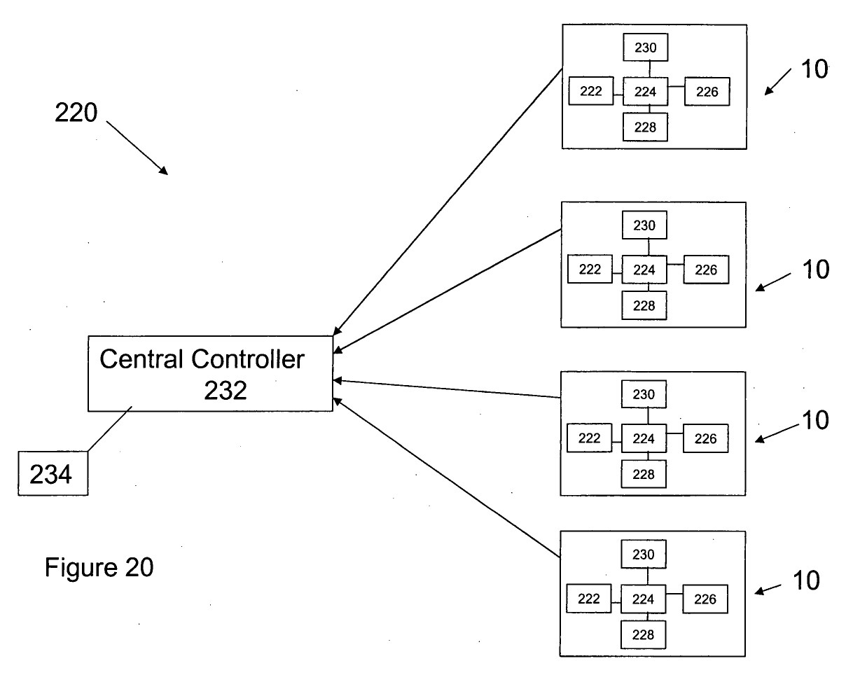

Referring now to FIG. 20, a system 220 for closing off and/or redirecting fluids traveling through a fluid delivery system is illustrated schematically. In this figure each of the components of the system are illustrated with a general reference to a designator or box with the understanding that any one of the devices described herein and equivalents thereof can be substituted into the referenced designator.

In accordance with an exemplary embodiment, the system will comprise at least one or a plurality of closing assemblies 10 each comprising a plurality of sensors 222 configured and positioned to determine whether the closing assembly is to be activated (e.g., closing off of the fluid pathway). In accordance with an exemplary embodiment, the sensors will be positioned to detect conditions indicative of damage to the conduit, changes in the velocity and/or flow of the fluid, etc. Non-limiting examples of sensors 222 include pressure sensors, temperature sensors configured to detect the external or internal temperature of conduit, velocity sensors configured to detect the velocity of media traveling in the conduit; vibration sensors; noise sensors; density sensors configured to detect the density of the media in the conduit; odor sensors; chemical sensors configured to detect the chemical composition of media flowing in the conduit; or any combination thereof. Sensors for detecting the aforesaid physical conditions are commercially available and are in operable communication with the control unit to provide signals indicative of the detected condition to the control algorithm of the control unit. Thereafter, and once the sensors 222 or a single sensor detects a predetermined condition has occurred, a signal will be generated to a device or microprocessor 224 configured to provide an activation signal to a closure apparatus 226 of the closing assembly, where the fluid path will be closed off using any one of the aforementioned closure devices or equivalents thereof. As used herein, one non-limiting example of the predetermined condition is a disruption or change in flow in the fluid delivery system requiring activation of the closure mechanism in order to close off a section of conduit.

Thereafter and once the system has been closed off, a closure detection sensor or sensors 228 will provide a single to the microprocessor wherein the microprocessor via a transmitter or transceiver 230 will provide an activation signal to a remotely located central controller 232. In accordance with an exemplary embodiment, controller 232 will have a user interface 234 (e.g., display screen, indicator light, etc.), which will provide an indication to an operator that this particular closure mechanism has been activated indicating a disruption in the flow of the fluid up the fluid delivery system.

In an alternative embodiment, the closure detection sensor or sensors are directly coupled to the transmitter or transceiver in order to provide the activation signal to the central controller 232.

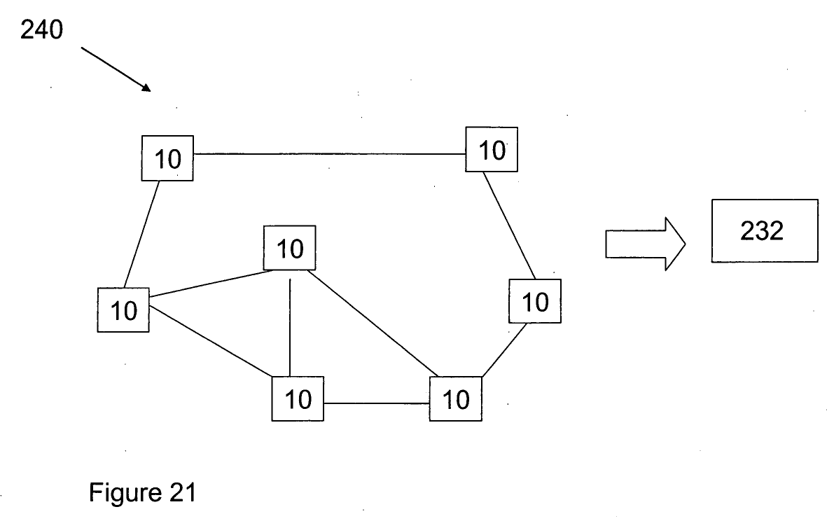

Referring now to FIG. 21, a schematic illustration of a fluid delivery system 240 is provided. In one exemplary embodiment, the fluid delivery system is an oil distribution network spanning many miles, wherein a plurality of remotely activated closure devices or assemblies 10 are located throughout the system. As described herein, each of the closure assemblies are configured to wirelessly transmit operational signals to a central controller 232, wherein the operational signals are indicative of the operational state of the closure assembly (e.g., closed or open). Accordingly, an operator monitoring central controller will through receipt of the signals will be able to determine the operational status of each of the closure assemblies. For example, if one of the remote closure assemblies has been activated a signal will be generated and sent to the central controller wherein an operator will be able to determine that a portion of the fluid distribution system has been shut down and/or rerouted and take the necessary steps (e.g., send out a repair crew). Moreover, and since the signals are capable of being transmitted throughout the globe (e.g., via satellite) the central controller can be located anywhere. In addition, since each of the closure assemblies is capable of being remotely activated (e.g., localized sensors providing activation signals to the closure assembly) the closure devices or assemblies are capable of remotely shutting down portions the fluid delivery system when a predetermined activation event has been detected and thereafter remotely providing an indication of the status of the closure device.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for closing off a path in a fluid delivery system, comprising:
a closing assembly providing a first fluid path between a first conduit and a second conduit, wherein the closing assembly comprises a remotely actuatable valve mechanism that closes the first fluid path and provides a second fluid path from either the first conduit or the second conduit to a third conduit, wherein the remotely acuatable valve mechanism closes the first fluid path when a predetermined condition is detected in the fluid delivery system; and
an indication device for remotely indicating whether the remotely acuatable valve mechanism has been activated, wherein the indication device wirelessly transmits a signal indicating the status of the remotely acuatable valve mechanism.

2. The apparatus as in claim 1, wherein the remotely acuatable valve mechanism further comprises an inflatable member, wherein the inflatable member is inflated when the predetermined condition is detected by at least one sensor disposed in the fluid delivery system, wherein the at least one sensor is configured to detect a fluid pressure in the fluid delivery system.

3. The apparatus as in claim 1, further comprising a control unit in operable communication with at least one sensor disposed in the fluid delivery system, the indication device, and the remotely acuatable valve mechanism, wherein the control unit will provide an activation signal to the remotely acuatable valve mechanism when the predetermined condition has been detected by the at least one sensor and the third conduit provides a energy absorbing system when the first fluid path is closed off.

4. The apparatus as in claim 1, wherein the energy absorbing system absorbs a shock in the fluid delivery system, wherein the shock is created by closing of the closing assembly.

5. The apparatus as in claim 3, further comprising a closure detection sensor, the closure detection sensor being configured to provide a signal to the control unit, indicating an operational status of the remotely acuatable valve mechanism.

6. The apparatus as in claim 5, wherein the indication device further comprises a transmitter for transmitting the signal indicating the status of the remotely acuatable valve mechanism and wherein the fluid delivery system is an oil distribution network.

7. The apparatus as in claim 6, wherein the remotely acuatable valve mechanism further comprises a sealing member pivotally mounted to a portion of the closing assembly for movement between an open position and a closed position, wherein the sealing member is moved into the closed position when the predetermined condition is detected by the at least one sensor.

8. The apparatus as in claim 7, wherein the sealing member is moved into the closed position by a sleeve member slidable received within the closing assembly.

9. The apparatus as in claim 6, wherein remotely activated valve mechanism comprises a pyrotechnically activated device.

10. An apparatus for closing off a path in a fluid delivery system, comprising:
a closing assembly providing a first fluid path between a first conduit and a second conduit, wherein the closing assembly comprises a remotely actuatable valve mechanism that closes the first fluid path between the first conduit and the second conduit, wherein the remotely acuatable valve mechanism closes the first fluid path when a predetermined condition is sensed by at least one sensor in the fluid delivery system; and
an indication device for remotely indicating whether the remotely acuatable valve mechanism has been activated, wherein the indication device wirelessly transmits a signal indicating the status of the remotely acuatable valve mechanism;
a control unit in operable communication with the at least one sensor, the indication device, and the remotely acuatable valve mechanism, wherein the control unit will provide an activation signal to the remotely acuatable valve mechanism when the predetermined condition has been detected by the at least one sensor;
a closure detection sensor, the closure detection sensor being configured to provide a signal to the control unit, indicating an operational status of the remotely acuatable valve mechanism.

11. The apparatus as in claim 10, wherein the indication device further comprises a transmitter for transmitting the signal indicating the status of the remotely acuatable valve mechanism and the fluid delivery system is an oil distribution network.

12. A closure detection system for a fluid delivery system having a plurality of pipes providing at least one flow path, the system comprising:
a plurality of closing assemblies each providing a fluid path therethrough, wherein each of the plurality of closing assemblies comprises a remotely actuatable valve mechanism that closes the fluid path when a predetermined condition is sensed by at least one sensor in the fluid delivery;
an indication device for each of the plurality of closing assemblies, the indication device being configured to remotely indicate whether the remotely acuatable valve mechanism of one of the plurality of closing assemblies has been activated, wherein the indication device wirelessly transmits a signal indicating the status of the remotely acuatable valve mechanism.

13. The closure detection system as in claim 12, wherein each of the plurality of closing assemblies further comprises a control unit in operable communication with the at least one sensor, the indication device, and the remotely acuatable valve mechanism, wherein the control unit will provide an activation signal to the remotely acuatable valve mechanism when the predetermined condition has been detected by the at least one sensor.

14. The closure detection system as in claim 13, wherein each of the plurality of closing assemblies further comprises a closure detection sensor, the closure detection sensor being configured to provide a signal to the control unit, indicating an operational status of the remotely acuatable valve mechanism.

15. The closure detection system as in claim 13, wherein the indication device of each of the closing assemblies further comprises a transmitter for transmitting the signal indicating the status of the remotely acuatable valve mechanism and wherein the fluid delivery system is an oil distribution network.

16. The closure detection system as in claim 13, wherein the indication device of each of the closing assemblies further comprises a transmitter for transmitting the signal indicating the status of the remotely acuatable valve mechanism and a receiver for receiving the signal indicating the status of the remotely acuatable valve mechanism of another one of the plurality of closing assemblies and wherein the fluid delivery system is an oil distribution network.

17. The closure detection system as in claim 12, wherein the remotely acuatable valve mechanism further comprises a sealing member pivotally mounted to a portion of the closing assembly for movement between an open position and a closed position, wherein the sealing member is moved into the closed position when the predetermined condition is detected by the at least one sensor.

18. A fluid delivery system, comprising:
a plurality of pipes providing at least one flow path;
a plurality of closing assemblies each providing a first fluid path between a one of the plurality of pipes and another one of the plurality of pipes, wherein the closing assembly comprises a remotely actuatable valve mechanism that closes the first fluid path and provides a second fluid path from one of pipes to yet another pipe, wherein the remotely acuatable valve mechanism closes the first fluid path when a predetermined condition is sensed by at least one sensor in the fluid delivery system proximate to each of the plurality of closing assemblies; and
an indication device for each of the plurality of closing assemblies, the indication device being configured to remotely indicate whether the remotely acuatable valve mechanism of one of the plurality of closing assemblies has been activated, wherein the indication device wirelessly transmits a signal indicating the status of the remotely acuatable valve mechanism.

19. The fluid delivery system as in claim 18, wherein each of the plurality of closing assemblies further comprises a control unit in operable communication with the at least one sensor, the indication device, and the remotely acuatable valve mechanism, wherein the control unit will provide an activation signal to the remotely acuatable valve mechanism when the predetermined condition has been detected by the at least one sensor and the second fluid path provides a shock absorbing dampener when the first fluid path is closed off.

20. The fluid delivery system as in claim 19, wherein each of the plurality of closing assemblies further comprises a closure detection sensor, the closure detection sensor being configured to provide a signal to the control unit, indicating an operational status of the remotely acuatable valve mechanism.

21. The fluid delivery system as in claim 20, wherein the indication device each of the closing assemblies further comprises a transmitter for transmitting the signal indicating the status of the remotely acuatable valve mechanism and wherein the fluid delivery system is an oil distribution network.

22. The fluid delivery system as in claim 18, wherein each of the plurality of closing assemblies further comprises a control unit for controlling the remotely acuatable valve mechanism wherein the at least one of sensor is configured to provide a signal to the control unit of the plurality of closing assemblies.

23. The fluid delivery system as in claim 21, further comprising a central monitoring and/or diagnostic system adapted to receive signal indicating the status of the remotely acuatable valve mechanism.

24. A method for closing off a path in a fluid delivery system, comprising:
monitoring a fluid traveling through the fluid delivery system with a plurality of sensors each of which is configured to provide an output signal corresponding to the fluid traveling through the fluid delivery system;
determining if there is a leak in the fluid delivery system by receiving the output signals; determining the location of the leak and determining which of a plurality of closing mechanisms are to be activated in order to isolate the leak, wherein a selected closing mechanism is activated in order to isolate the leak, wherein each closing mechanism provides a first fluid path between a first conduit and a second conduit, and each closing mechanism comprises a remotely actuatable valve mechanism that closes the first fluid path and provides a second fluid path from either the first conduit or the second conduit to a third conduit, wherein the remotely acuatable valve mechanism closes the first fluid path in response to a signal from one of the plurality of sensors; and
indicating that the selected closing mechanism has been activated by providing an indication signal to a central controller in operable communication with the fluid delivery system.

25. The method as in claim 24, wherein each closure mechanism further comprises a transmitter for wirelessly transmitting the indication signal to the central controller.
